(19) United States
(12) Patent Application Publication
(10) Pub. No.: US 2026/0339902 A1
(43) Pub. Date: Oct. 29, 2026

(54) DYNAMIC AUTOMATED CLAIMS MATCHING AND MERGING ACROSS DISPARATE ELECTRONIC DATA SETS

(71) Applicant: Briotix Health, LP, Centennial, CO (US)

(72) Inventors: Seth SCHOFIELD, Aurora, CO (US); Vadym KOVADLO, Kyiv (UA)

(21) Appl. No.: 19/191,744

(22) Filed: Apr. 28, 2025

(51) Int. Cl. G06F 16/21; G06N 5/022

(52) U.S. Cl. CPC G06F 16/211; G06N 5/022

(57) ABSTRACT

Embodiments of the present invention generally relate to methods of dynamic automated claims matching across disparate electronic data sets. Embodiments generally include parsing a first electronic data table and a second electronic data table according to a set of rules to map body parts to configured body part categories. Embodiments include evaluating, with reference to a given row in the first electronic data table that is mapped to a particular body part category based on the parsing, rows of the second electronic data table to identify one or more matching rows. Embodiments include generating a primary key, not present in the first electronic data table and the second electronic data table, representing an incident relating to the particular body part category, the person, and the date range. Embodiments include assign the primary key to the given row and the one or more matching rows based on the evaluating.

### BACKGROUND OF THE INVENTION

### Field of the Invention

Embodiments disclosed herein generally relate to automated matching and merging of electronic data related to workplace injury claims across disparate electronic data sets. More specifically, embodiments generally relate to methods of overcoming technical limitations imposed by electronic data sets lacking primary keys and/or differing in data storage format such that existing automated matching techniques are unable to match and merge records across such data sets.

### Description of the Related Art

Millions of workplace injuries and illnesses are reported by private industry employers annually, resulting in billions of dollars in direct economic costs to employers. Data related to workplace injuries may be captured and stored in a variety of different electronic data formats and in a variety of different contexts. Not all data related to a workplace injury is generally stored in direct association with a record of a workplace injury claim stemming from the injury. For example, an employee may perform various actions, may be involved in various encounters, may receive various types of services, and/or may otherwise provide data related to a workplace injury in many different contexts, and records of such data may be stored in electronic data sets that are independent of one another and that differ in format and identifying information.

Connecting related data from such disparate electronic data sources may provide many advantages, such as for use in predicting, planning, prevention, and/or other types of actions related to workplace injuries. However, existing automated data matching techniques are unable to identify and establish such connections due to the variations in data storage format and the lack of any primary key across such differing sources that could otherwise be used to link related data items.

As such, there is a need in the art for improved techniques for automated matching and merging of electronic data related to workplace injury claims across disparate electronic data sets.

### SUMMARY OF THE INVENTION

Embodiments disclosed herein generally relate to methods of dynamic automated claims matching across disparate electronic data sets. In one embodiment, a method of dynamic automated claims matching across disparate electronic data sets can include: parsing a first electronic data table and a second electronic data table according to a set of rules to map body parts indicated in table entries to configured body part categories; evaluating, with reference to a given row in the first electronic data table that is mapped to a particular body part category of the configured body part categories based on the parsing, rows of the second electronic data table to identify one or more matching rows that are mapped to the particular body part category and that reference a person and date range that are referenced by the given row; generating a primary key representing an incident relating to the particular body part category, the person, and the date range, wherein the primary key is not present in the first electronic data table and the second electronic data table; assigning the primary key to the given row and the one or more matching rows based on the evaluating; merging the given row and the one or more matching rows into an object representing the incident in a unified electronic data table based on the assigning of the primary key; and searching the unified electronic data table based on the primary key to retrieve the object.

In other embodiments, a computing system may be configured to perform any of the above methods. In some embodiments, a computing system comprises one or more processors and a memory storing instructions that, when executed using the one or more processors, cause the computing system to perform any of the methods described above and/or below. Certain embodiments include a non-transitory computer readable medium storing instructions that, when executed using one or more processors of a computing system, cause the computing system to perform any of the methods described above and/or below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an illustration of example computing components related to automated claims matching across disparate electronic data sets, according to certain embodiments.

FIG. 2 is an illustration of an example workflow related to automated claims matching across disparate electronic data sets, according to certain embodiments.

FIG. 3 is an illustration of an example workflow related to training a machine learning model based on automated claims matching across disparate electronic data sets, according to certain embodiments.

FIG. 4 is an illustration of an example workflow related to using a machine learning model trained based on automated claims matching across disparate electronic data sets, according to certain embodiments.

FIG. 5 is a flow diagram of a method of automated claims matching across disparate electronic data sets, according to certain embodiments.

FIG. 6 is block diagram of a system configured to implement one or more aspects related to automated claims matching across disparate electronic data sets, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present invention generally relate to automated claims matching across disparate electronic data sets. Data related to workplace injuries may be stored in a variety of different electronic data sets, such as differing in data storage format and context and lacking a primary key that would otherwise enable an automated matching technique to link such data together. For example, records of an employee's encounters with health advisors or physical therapists, records of an employee's actions or reports related to injuries, and/or other injury related data may be stored independently of records of workplace injury claims filed by the employee, in different electronic data storage formats and including different types of information and identifying details. The siloed nature of such electronic data sets presents technical challenges for any technique that seeks to automatically match and merge such data.

Embodiments disclosed herein provide methods and systems to overcome such technical challenges through the use of particular automated processes that abstract, compare, match, disambiguate, assign primary keys to, merge, and augment data items across disparate electronic data sets.

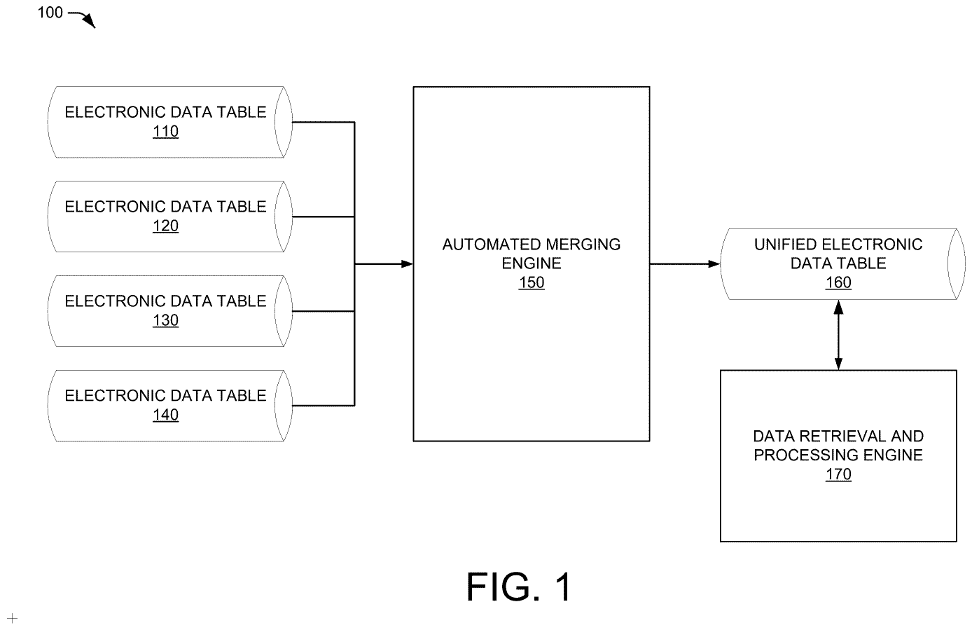

As described in more detail below with respect to FIG. 1, an automated merging engine may receive electronic data from multiple sources, such as different electronic data tables. For example, the electronic data tables may be from sources that store data related to workplace injury claims, injury-related encounters with employees, reports of actions or other data connected to injuries, and/or the like. The electronic data from the different sources may lack linking characteristics such as primary keys, common identifiers, shared value types, shared numbers and/or types of columns, and/or the like. The automated merging engine may parse the electronic data tables from the various sources to identify references to particular entities such as body parts, and may map such entities to higher level categories according to configured rules. For example, the automated merging engine may map all references to body parts in the electronic data tables to body part categories that may include multiple body parts within each category, resulting in a higher level of abstraction for the electronic data.

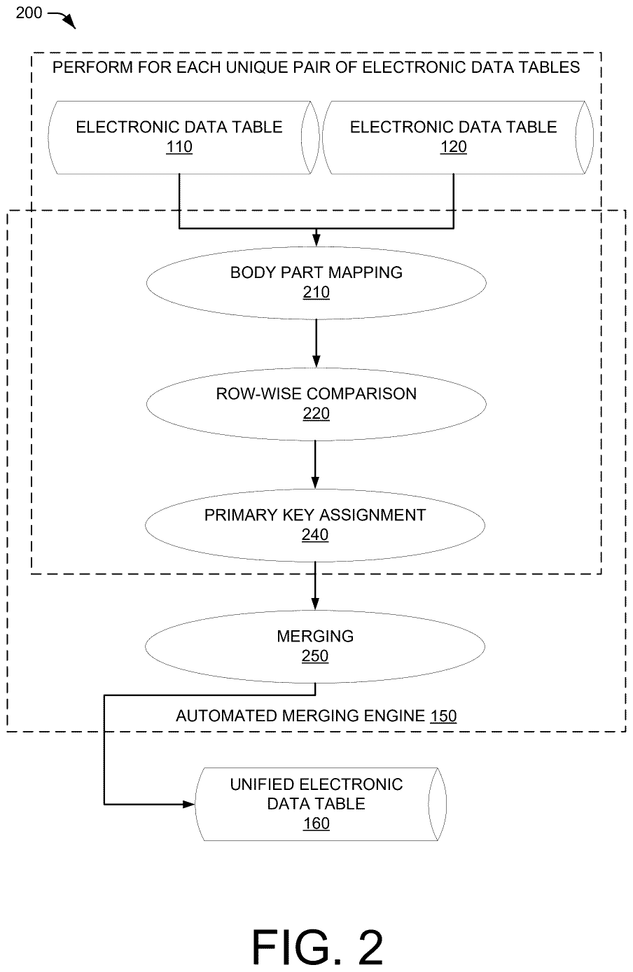

As described in more detail below with respect to FIG. 2, the automated merging engine may then compare each row of one electronic data table to each row of another electronic data table according to automated matching logic that looks for particular match indicators. For example, match indicators may include whether two rows reference a shared body part category (e.g., based on the mapping described above), a shared person, a shared date range, and/or the like. Once such automated matching logic has been applied (e.g., to all rows of all tables), the automated merging engine may disambiguate any many-to-one or many-to-many matches that were identified. For example, if one record from physical therapy encounters was identified as a match for multiple records of workplace injury claims, disambiguation may be performed to determine which workplace injury claim the physical therapy encounter reference is most likely related to. Disambiguation may be based on degrees of similarity (e.g., which pair of rows is closest in date), comparison of additional attributes (e.g., that were not compared during the initial matching logic), and/or the like.

Once a set of two or more rows from two or more electronic data tables have been identified as relating to the same underlying incident, the automated merging engine may generate a primary key for the incident and may assign the primary key to the two or more rows. The assigning of the primary key establishes an electronic link between all rows (e.g., from multiple tables) relating to a particular incident. The primary keys may be used to merge all rows that relate to each given incident from the various electronic data tables into a unified electronic data table. For example, the automated merging engine may perform such automated merging based on primary keys, and may perform additional unifying, abstracting, and/or augmenting logic as part of the merging. Such logic may include populating particular columns in the unified electronic data table based on particular rules, such as choosing values from particular types of electronic data tables over other types of electronic data tables, mapping attributes to higher-level categories, setting values based on determinations (e.g., storing an indicator in the unified electronic data table of whether an employee underwent injury prevention training), and/or the like. Each “object” in the unified electronic data table may include the primary key of a particular incident along with a set of applicable data (e.g., merged in from multiple electronic data tables) for that incident. Thus, the unified electronic data table may be used to efficiently search for and retrieve, via a primary key, such disparate data about a particular incident in an efficient and accurate manner that is not possible with prior techniques.

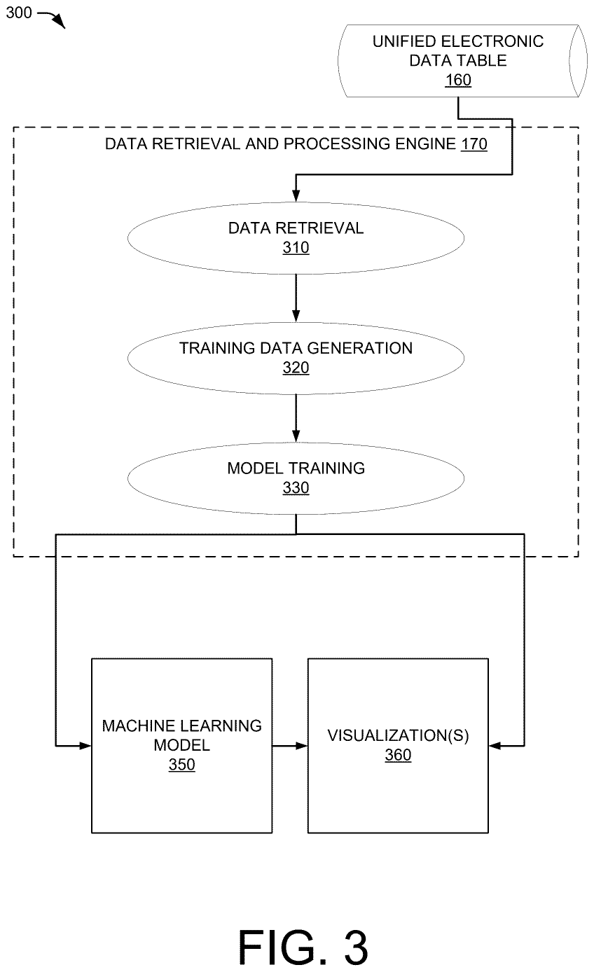

Once merged, the unified electronic data table may be used for a variety of useful purposes. For example, as described in more detail below with respect to FIG. 3, the unified electronic data table may be used to generate a training data set for training a machine learning model. The training data may, for instance, include, for each of multiple incidents, attributes related to the incident associated with a ground truth label indicating whether a workplace injury claim was filed in connection with the incident. In some aspects, ground truth labels may also include other data related to such workplace injury claims, such as types of injuries, outcome data, costs, and/or the like. A supervised learning technique may be used to train the machine learning model based on the training data, such as iteratively adjusting parameters of the model based on comparing outputs produced by the model (e.g., in response to particular sets of training inputs) to corresponding ground truth labels.

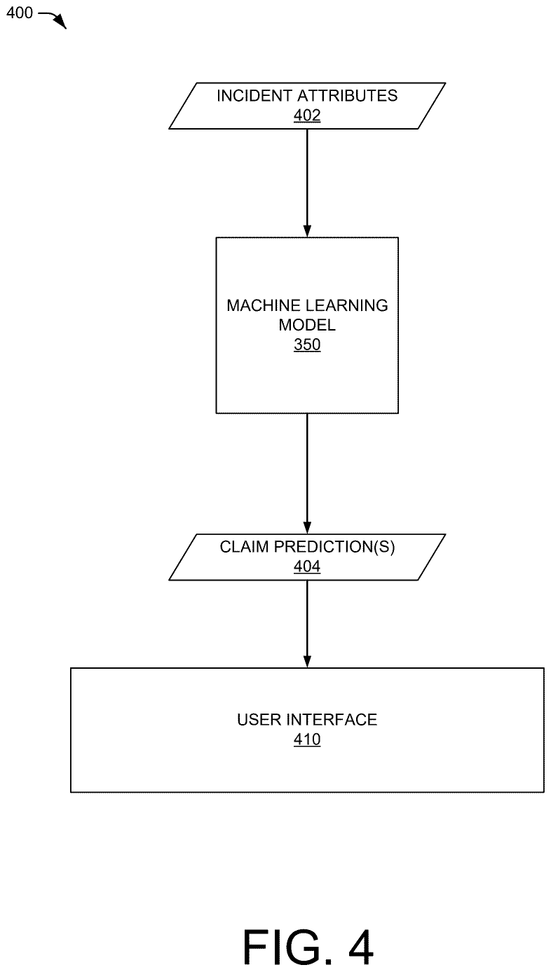

As described in more detail below with respect to FIG. 4, the machine learning model may be used, once trained, to predict whether a workplace injury claim is likely to be filed in a given case based on input attributes related to an incident. In some aspects, the machine learning model may also predict other types of data related to workplace injury claims that are predicted to be filed, such as types of injuries, outcome data, costs, and/or the like.

In some cases, one or more visualizations may be generated based on the unified electronic data table. For example, a visualization may depict (e.g., in the form of a graph, chart, or other illustrative structure) a distribution of particular attributes relative to a particular target variable such as whether a workplace injury claim was filed. In other examples, a visualization may depict (e.g., in the form of a graph, chart, or other illustrative structure) metrics related to machine learning model performance, such as false positives and/or false negatives, such as showing which attributes are most correlated with false positives or false negatives. In certain cases, one or more visualizations may be generated based on results of a machine learning model training process.

Various types of content may be displayed via a user interface based on the unified electronic data table and/or a machine learning model trained as described herein. For example, data from the unified electronic data table may be displayed, a visualization may be displayed, a prediction output by a machine learning model may be displayed, statistical and/or analytical data related to the unified electronic data table may be displayed, and/or the like. Furthermore, the unified electronic data table and/or a prediction from a machine learning model described herein may be provided to one or more components of a computing application for further processing, such as related to analyzing and/or extracting insights from such data and/or for making determinations of other actions to perform (e.g., re-training the machine learning model based on updated training data generated in response to data that indicates the model has performed poorly in a particular aspect).

As used herein, “electronic data” may refer to data that is stored and/or processed on a computing device, such as residing in volatile memory and/or persistent storage of such a computing device.

Techniques described herein provide many technical improvements with respect to prior techniques for automated matching, merging, and/or processing data related to workplace injuries from disparate electronic data sources. For example, aspects of the present disclosure overcome the technical problem posed by the absence of primary keys across multiple different electronic data tables from different sources by dynamically matching rows from different data tables according to unique automated matching logic, and generating and assigning primary keys to matched rows for use in merging such matched rows into a unified electronic data table. Techniques described herein overcome the technical challenge posed by data being stored in different data storage formats and/or with different types and/or numbers of columns by automatically mapping certain attributes (e.g., body parts) to configured categories, disambiguating attributes and matches based on particular disambiguation rules, augmenting and/or abstracting values to generate a unified electronic data set, and/or the like. Once created through merging techniques described herein, a unified electronic data table may be efficiently queried (e.g., using the automatically generated and assigned primary keys) to retrieve disparate types of data related to a given incident in a manner that was not possible with prior techniques. With prior techniques, even if the relevant rows from multiple electronic data tables were known (which prior automated matching techniques are unable to accomplish), retrieving such data would require submitting different types of queries based on different keys to multiple electronic data tables, thereby expending significant amounts of computing resources and time, and the resulting data set would not be unified or efficiently usable for further processing. Techniques described herein, however, enable a single query to be submitted to the unified electronic data table to retrieve all applicable electronic data related to a particular incident based on a primary key, utilizing significantly fewer computing resources and less time than would be otherwise required, and result in a retrieved data set that is unified and ready to be efficiently processed for a variety of useful purposes.

Additionally, by automatically generating comprehensive training data based on the unified electronic data table, aspects of the present disclosure enable a machine learning model to be trained in a manner that was not possible with prior techniques to accurately predict whether a workplace injury claim is likely to be filed (and, in some embodiments, attributes of such a predicted claim) based on attributes related to an incident (e.g., injury). Furthermore, visualizations and/or other types of content and/or information may be generated or derived based on the unified electronic data table and/or the training of the machine learning model, thereby enabling such information (which could not be otherwise produced) to be provided via a user interface. Thus, aspects of the present disclosure overcome many technical challenges related to automated matching and merging of disparate electronic data sets in order to produce various technical improvements that could not be otherwise accomplished.

FIG. 1 is an illustration 100 of example computing components related to automated claims matching across disparate electronic data sets, according to certain embodiments.

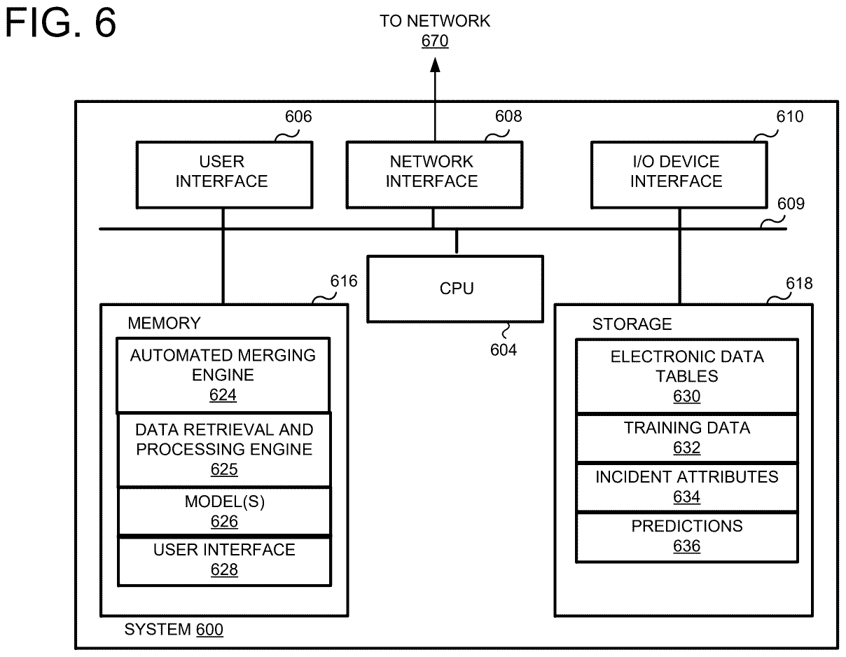

In illustration 100, an automated merging engine generally represents a software component executing on one or more computing devices, such as system 600 of FIG. 6 (described below). While depicted as a single component, functionality described with respect to automated merging engine 150 may be performed by one or more components. According to certain aspects, automated merging engine 150 may receive electronic data tables 110, 120, 130, and 140 from different electronic data sources. For example, electronic data tables 110, 120, 130, and 140 may represent different types of data that may potentially be relevant to particular incidents such as workplace injuries, and may be representative of more or fewer electronic data tables.

In a particular example, electronic data table 110 represents data stored in connection with workplace injury records (e.g., maintained by an employer), electronic data table 120 represents data stored in connection with encounters between employees and health professionals (e.g., maintained by an injury prevention service provider), electronic data table 130 represents data stored in connection with reports of injuries or associated encounters that are not directly connected with workplace injury claims (e.g., maintained by the employer), and electronic data table 140 represents other data stored in connection with injuries (e.g., maintained by a different third-party service provider, such as a competitor of the injury prevention service provider). The rows in electronic data tables 110, 120, 130, and 140 may include different numbers of columns, different types of columns, different data storage formats, different types of information, different identifiers, and/or the like, and may lack primary keys that would otherwise enable an automated matching technique to connect related data across electronic data tables 110, 120, 130, and 140 together. For example, while electronic data table 110 may include identifiers of workplace injury claims, may identify body parts according to a particular nomenclature and/or categorical distribution, and may refer to employees using a particular type of employee identifier (e.g., name), electronic data table 120 may not include any identifiers of workplace injury claims, may identify body parts according to a different nomenclature and/or categorical distribution, and/or may refer to employees using a different type of employee identifier (e.g., email address or phone number). These are included as examples of discrepancies between electronic data tables, and many other types of differences and incompatibilities are possible.

Automated merging engine 150 may receive electronic data tables 110, 120, 130, and 140, and may perform particular automated merging logic in order to generate a unified electronic data table 160 based on electronic data tables 110, 120, 130, and 140. Example aspects of such automated merging logic are described in more detail below with respect to FIG. 2, and may include mapping body parts to configured body part categories, comparing particular types of attributes (e.g., using particular comparison techniques) to identify matching rows, disambiguating many-to-one and/or many-to-many matches, generating and assigning primary keys, augmenting and/or abstracting values, and/or otherwise merging matched rows together based on assigned primary keys to form a consistent, unified, and efficiently usable electronic data set about each of a plurality of incidents.

Unified electronic data table 160 may be used by a data retrieval and processing engine 170 to efficiently retrieve unified data about particular incidents (e.g., by querying unified electronic data table 160 using the assigned primary keys) without the need to query any of electronic data tables 110, 120, 130, and/or 140 and/or to identify which data in such tables is relevant to a given incident (which would not be possible using prior automated matching techniques). Examples of actions that may be performed by one or more components such as data retrieval and processing engine 170 based on unified electronic data table 160 are described below with respect to FIGS. 3 and 4, such as training and using a machine learning model to predict whether workplace injury claims are likely to be filed (e.g., and, in some aspects, attributes related to such predicted claims) based on attributes of incidents.

FIG. 2 is an illustration 200 of an example workflow related to automated claims matching across disparate electronic data sets, according to certain embodiments. Illustration 200 includes electronic data tables 110 and 120, automated merging engine 150, and unified electronic data table 160 of FIG. 1. Functionality depicted and described with respect to electronic data tables 110 and 120 for FIG. 2 may also be performed for other combinations of electronic data tables 110, 120, 130, and 140 of FIG. 1.

Automated merging engine 150 receives electronic data tables 110 and 120, and performs body part mapping 210 in order to map body parts indicated in electronic data tables 110 and 120 to configured body part categories. Such mapping may also be performed for electronic data tables 130 and 140 of FIG. 1. The configured body part categories may represent groupings of body parts that are typically closely related to one another for purposes of analyzing data related to workplace injuries. Examples of body part categories may include forearm (which may include the elbow, lower arm, and wrist), upper arm (which may include the shoulder, bicep, and complete upper arm), and/or the like. At body part mapping 210, any reference in electronic data tables 110 and 120 to a particular body part (e.g., wrist) may be mapped to an applicable body part category (e.g., forearm) that includes the particular body part based on configured rules.

After body part mapping 210, automated merging engine 150 may perform row-wise comparison 220 of electronic data tables 110 and 120 to identify matching rows. Such comparison may also be performed for other combinations of electronic data tables 110, 120, 130, and 140 of FIG. 1 (e.g., for each pair of electronic data tables). Row-wise comparison 220 may involve moving through each row of one of electronic data tables 110 and 120 (e.g., the smaller of the two tables, such as the table with the smaller number of rows) and comparing that row to each row of the other one of electronic data tables 110 and 120. For example, automated merging engine 150 may, for each row of electronic data table 110, compare that row to each row of electronic data table 120 to determine whether the rows meet matching criteria.

The matching criteria evaluated at row-wise 220 may include whether two rows share one or more particular characteristics, such as having the same or similar values for one or more particular attributes. In one example, two rows are considered a match at row-wise comparison if the two rows reference the same body part category (e.g., reference one or more body parts that were mapped to the same body part category at body part mapping 210), the same person (e.g., based on comparing employee identifiers to one another according to particular logic, such as string matching, edit distance, value extraction, whether identifiers are otherwise known to be associated with the same employee, and/or the like), and the same date range (e.g., if dates indicated in the two rows are within a threshold number of days from one another). A date range indicated in matching logic may be configurable. These are included as examples, and other matching criteria may be employed at row-wise comparison 220. In some cases, data formatting, abstraction, extraction, and/or analysis may be performed as part of row-wise comparison 220, such as to convert dates that are stored in differing formats (e.g., MM-DD-YY versus Month Day, Year) into a unified format for comparison, to extract a name from an email address (e.g., using regular expressions of other rules) in one row to compare to a name from the other row (e.g., using fuzzy matching, edit distance, and/or the like), to determine that two employee identifiers are both associated with the same employee in a separate data source (e.g., an employee information database), and/or the like.

Any rows identified as matches may be preserved for further processing. For example, any one-to-one matches may require no further disambiguation. Some one-to-many matches may also require no further disambiguation, such as matches between one row in a table of workplace injury claims data and multiple rows in a different table such as a table of health services encounters data (e.g., because multiple health services encounters may be related to the same workplace injury claim). However, some many-to-one or many-to-many matches may call for further disambiguation, such as matches between multiple rows in a table of workplace injury claims data and one row in a different table such as a table of health services encounters data (e.g., because each given health services encounter should only be related to one workplace injury claim). Thus, row-wise comparison 220 may further include disambiguation of any such matches according to disambiguation logic.

Disambiguation of matches may include, for example, determining which of multiple candidate matches has a highest level of similarity (e.g., which pair of rows is closest in date, closest in employee identifier, and/or the like), which of the multiple candidate matches shares one or more additional characteristics (e.g., based on comparing different attributes than those compared during the initial matching), and/or the like. In one example, disambiguation between two different workplace injury claim rows for a particular health services encounter row involves comparing certain additional attributes (e.g., geographic location, department, supervisor, job title, specific body part rather than body part category, injury type, and/or the like) of the particular health services encounter row to corresponding attributes in each of the two different workplace injury claim rows to determine which of those two is most similar to the particular health services encounter row.

Comparison of attributes during the initial matching and/or during disambiguation may involve a variety of different comparison techniques. In some cases, the comparison technique may be specific to the attribute type that is being compared. For example, body part categories may be directly compared for a match. However, other strings such as employee identifier, geographic location, job title, or department may be compared using a fuzzy matching technique, such as involving edit distance, n-gram comparison, comparison of embeddings or vector representations (e.g., which may be generated using an embedding model, such as a machine learning model trained to generate embeddings that represent strings or other values as vectors in n-dimensional space such that similar values are closer to one another in the vector space), and/or the like. Some types of attributes may be compared based on determining whether the values for the attributes in the two rows belong to a common category, have a common classification, are associated with a common entity (e.g., based on data in one or more other data sources), and/or the like.

Furthermore, at row-wise comparison 220, rows from different tables that are not directly matched with each other but that share another common matching row from another table may also be determined to be matched with each other. For example, a match between a row in a second table and a row in a third table may also result in the row in the third table being matched to a row in a first table that was matched to the row in the second table, even if no direct match was identified between the row in the first table and the row in the third table. This may occur because of the configured data range, for example. While the row in the first table and the row in the second table may be within the configured date range of each other and the row in the second table and the row in the third table may also be within the configured date range of each other, the row in the first table and the row in the third table may not be within the configured data range of each other. Nevertheless, in certain embodiments, it may be advantageous for automated matching logic to be highly inclusive, such as identifying a match based on indirect matching criteria (e.g., sharing a common matched row from another table) to ensure maximum data unification and enrichment.

Once matches have been identified and disambiguated as appropriate (e.g., such that each row in a table other than a workplace injury claims table is matched to only one row in the workplace injury claims table), automated merging engine 150 may perform primary key assignment 240. For example, primary key assignment 240 may involve generating a primary key for each unique incident (e.g., workplace injury) and assigning that primary key to all rows that are determined based on row-wise comparison 220 to be associated with that incident. For example, each group of matching rows from two or more tables that is identified as a result of row-wise comparison 220 may be determined to be associated with a unique incident, a primary key may be generated for that unique incident, and the primary key for that unique incident may be assigned to the group of rows associated with that unique incident. The primary key may be a string, a numerical identifier, or the like that uniquely identifies the incident relative to other incidents. Primary keys may be assigned by storing the primary keys in corresponding rows within their respective electronic data tables, by associating the primary keys with corresponding rows in temporary storage (e.g., memory), and/or may be associated with corresponding rows as part of merging 250 by storing the primary keys in the newly created rows in unified electronic data table 160.

At merging 250, automated merging engine 150 merges, based on primary key assignment 240, each group of matched rows into a corresponding object (e.g., comprising one or more rows), including the corresponding primary key, in a newly created unified electronic data table 160. Unified electronic data table 160 may have a configured set of columns, each of which may or may not be populated for each row that is created at merging 250. Some columns may be mandatory while other columns may be optional. Merging 250 can only create a given row in unified electronic data table 160 if data needed to populate all mandatory columns for that given row is available. Merging 250 may include applying logic for determining how to populate particular columns for each newly created row. For example, if a row from electronic data table 110 includes one value for department while a matched row from electronic data table 120 includes a different value for department, merging 250 may involve selecting between these two values based on one or more rules (e.g., based on the type of the electronic data table from which each value originated, such as favoring a workplace injury claims table over one or more other types of tables) and populating the department column in the corresponding newly created row(s) of unified electronic data table 160 with the selected value. Populating some columns in unified electronic data table 160 may be based on aggregating information across multiple rows in a matched group, such as computing a sum (e.g., a total cost), an average, a count (e.g., a count of health services encounters associated with an incident), and/or the like.

Merging 150 produced unified electronic data table 160, which may store a plurality of objects, each object comprising one or more rows related to a particular incident and including the primary key corresponding to the particular incident. Each row may store a variety of attributes, such as employee identifier, body part category, date(s) (e.g., date of first encounter or record related to the incident, date of last encounter or record related to the incident, date claim was filed, date claim was resolved, and/or the like), workplace injury claim identifier, geographic location, department, job title, length of employment, type of injury, description of injury, notes or other details related to claim(s) or encounter(s), number of health-related encounter(s), cost(s) associated with a claim, information about whether injury prevention training or services had been received by the employee prior to the incident, information about an employee's medical condition(s) and/or fitness, and/or the like.

Unified electronic data table 160 may be efficiently queried using the assigned primary keys in order to retrieve a unified and comprehensive set of data about a particular incident, such as for use in further processing as described herein.

FIG. 3 is an illustration 300 of an example workflow related to training a machine learning model based on automated claims matching across disparate electronic data sets, according to certain embodiments. Illustration 300 includes unified electronic data table 160 of FIGS. 1 and 2 and data retrieval and processing engine 170 of FIG. 1

The functionality depicted and described with respect to illustration 300 is included as an example, and the automated matching and merging techniques described herein may be used independently of such examples and/or for other types of use cases.

Data retrieval and processing engine 170 may perform data retrieval 310 by querying unified electronic data table 160 for data related to one or more incidents, such as using one or more primary keys. For example, data retrieval 310 may involve retrieving a plurality of objects related to a plurality of incidents for use in generating training data for a machine learning model.

At training data generation 320, data retrieval and processing engine 170 may perform various processing steps on the retrieved data in order to generate a training data set that includes particular attributes of incidents associated with labels (e.g., ground truth labels). The attributes of incidents that are included in each training data instance may include, for example, body part category, geographic location, department, job title, information about whether injury prevention training or service(s) were received by the employee prior to the incident, information about an employee's medical condition(s) and/or fitness, length of employment, type of injury, description of injury, notes or other details related to encounter(s), and/or the like. The label(s) associated with each training data instance may include, for example, whether a workplace injury was filed in connection with the incident and, in some aspects, one or more attributes related to such a workplace injury claim (e.g., total cost to the employer associated with the claim, time to resolve the claim, employee health outcome information, and/or the like).

The attributes in each training data instance may be encoded into a numerical form as appropriate, such as into binary form. For example, attributes such as body part category, geographic location, department, job title, and/or the like may be converted into one-hot encoded vectors. Whether injury prevention training or service(s) were received by the employee prior to the incident may be encoded into a binary value indicating whether or not any such services had been received. Other types of attributes may be encoded into embeddings or other vector representations. These types of feature encoding are included as examples, and other forms of feature encoding are possible. Labels may be binary (e.g., a claim was or was not filed), numerical (e.g., a total cost), and/or the like.

In some aspects, training data generation 320 involves excluding from the training data any incidents with one or more attribute values that are outliers compared to other incidents. For example, if one retrieved row from unified electronic data table 160 includes a value for a particular attribute (e.g., department) that is included in fewer than a threshold number of other retrieved rows from unified electronic data table 160, then that one retrieved row may be excluded from use in generating the training data (e.g., because atypical or outlier values may skew the training data and/or may not have predictive value in most cases).

Once the training data is generated, data retrieval and processing engine 170 may perform model training 330 for a machine learning model 350 based on the training data. Model training 330 may comprise a supervised learning process. For example, a supervised learning process may involve providing training inputs (e.g., a set of attributes of an incident from the training data) to machine learning model 350, receiving outputs (e.g., predicting whether a workplace injury claim is likely to be filed and, in some embodiments, one or more attributes of a predicted claim) from machine learning model 350 in response to the training inputs, and iteratively adjusting parameters of machine learning model 350 based on comparing the predictions to labels (e.g., ground truth labels from the training data) associated with the training inputs until one or more conditions are met. The one or more conditions may involve, for example, determining whether the predictions produced by the model match the labels, optimizing a cost function, determining whether a measure of error between training iterations is not decreasing or not decreasing more than a threshold amount, and/or the like. Parameters adjusted during training may include, for example, weights, biases, hyperparameters, values related to numbers of iterations, functions used by nodes to calculate scores, and/or the like. In one example, a decision tree supervised learning algorithm is used to train machine learning model 350. For example, machine learning model 350 may be a tree-based machine learning model such as a decision tree, random forest, gradient boosted tree, and/or the like. In other examples, machine learning model 350 may be a neural network, a support vector machine, a naive Bayes classifier, and/or the like.

After model training 330, machine learning model 350 may be used to predict whether a workplace injury claim is likely to be filed and, in some aspects, one or more attributes of such a predicted claim, based on input attributes of an incident. An example of using machine learning model 350 for such a prediction is described below with respect to FIG. 4. Feedback may be received from a user or other ground truth feedback may be determined with respect to one or more predictions generated by machine learning model 350, and the feedback may be used to generate new training data for use in retraining machine learning model 350. For example, if machine learning model 350 predicts that a workplace injury claim will not filed for a given incident but subsequent user feedback or other ground truth feedback is received indicating that a predicted workplace injury claim was actually filed for the incident (e.g., ground truth feedback may be in the form of receiving data indicating that the claim was filed, such as from a workplace injury claim table or data source), then this feedback may be used to assign a label to a new training data instance that includes the attributes of the incident (e.g., the label may indicate that a claim was filed and, in some embodiments, may indicate one or more attributes of the claim that was filed). The new training data may be used to retrain machine learning model 350 in the manner described above with respect to model training 330, thereby improving the performance and accuracy of machine learning model 350 through an interactive feedback loop that reduces false positives and/or false negatives produced by machine learning model 350.

Additionally, one or more visualizations 360 may be generated as a result of model training 330 (and/or otherwise as a result of analyzing unified electronic data table 160). For example, visualization(s) 360 may include visual (e.g., graphical) representations of metrics, distributions, trends, and/or other insights related to the data in unified electronic data table 160. In one example, a visualization 360 includes a diagram (e.g., a sankey diagram, which is a visualization used to depict a flow from one set of values to another) that depicts a distribution of input attribute values relative to whether a workplace injury claim was filed. Such a visualization may be useful for determining which attribute values are most highly correlated with workplace injury claims being filed (e.g., which body part categories, departments, locations, job titles, etc. are most commonly associated with workplace injury claims being filed). In another example, a visualization 360 may depict (e.g., via a confusion matrix) which input attribute values are most highly correlated with false positives and/or false negatives produced by machine learning model 350 during training. Such a visualization may be useful in determining how training data can be improved in order to improve the performance of the model, such as generating new labeled training data focused on the problem attribute values indicated in the visualization.

Visualization(s) 360 may also be useful to display via a user interface in order to provide data related to which departments, job titles, locations, and/or the like are most commonly associated with workplace injury claims being filed, such as enabling one or more users to analyze and/or take preventive action in those particular areas. Visualization(s) 360 are included as an example of outputs that may be displayed via a user interface, and other types of output may also be displayed based on unified electronic data table 160, model training 330, and/or output(s) generated by machine learning model 350. For example, an indication of which attribute values are most highly correlated with workplace injury claims being failed and/or most highly correlated with false positives and/or negatives may be displayed in the form of text and/or via other output techniques. In other embodiments, contents retrieved from unified electronic data table 160 may be displayed via a user interface.

FIG. 4 is an illustration 400 of an example workflow related to using a machine learning model trained based on automated claims matching across disparate electronic data sets, according to certain embodiments. Illustration 400 includes machine learning model 350, which may have been trained as described above with respect to model training 330 of FIG. 3.

Incident attributes 402 may be provided as inputs to machine learning model 350. For example, incident attributes may include attributes related to an incident (e.g., injury) that has not yet resulted in a workplace injury claim being filed, such as derived from one or more electronic data tables and/or other data sources. For example, incident attributes 402 may include a body part category (e.g., a body part from an electronic data table row may be mapped to the body part category as described above), a location, a department, a job title, an indication of whether any injury prevention services has been received by the employee, and/or the like.

Machine learning model 350 may output one or more claim predictions 404 in response to incident attributes 402. For example, claim prediction(s) 404 may include an indication of whether a workplace injury claim is predicted to be filed based on the inputs, one or more attributes of a predicted workplace injury claim (e.g., a predicted amount of time until the claim is filed, a predicted amount of time to resolve the claim, a predicted total cost to the employer of the claim, and/or the like). In some embodiments, claim prediction(s) 404 are also output by machine learning model 350 with one or more confidence scores, such as indicating a confidence that each prediction is correct.

Claim prediction(s) 404 may be displayed via a user interface 410. For example, user interface 410 may be a graphical user interface associated with a software application, and may be displayed via a display screen of a computing device (e.g., desktop computer, server computer, laptop computer, tablet, mobile device, and/or the like). Claim prediction(s) 404 may be output via user interface 410 in the form of text, images, audio, video, and/or the like, and may generally indicate whether a workplace injury claim is likely to be filed based on incident attributes 402, any predicted attributes of such a predicted workplace injury claim, confidence score(s) associated with the prediction(s), and/or the like. In some embodiments, a claim prediction 404 is only output via a user interface 410 if it is associated with a confidence score above a threshold.

Claim prediction(s) 404 may also be used for one or more other purposes, such as generating visualization(s), determining whether to perform additional operations or display other content, determining whether to recommend one or more preventive actions (e.g., which may be output via user interface 410), and/or the like. For example, claim prediction(s) 404 may be provided to one or more other components of a software application for further processing, such as to aggregate multiple predictions and generate content to display based on the multiple predictions, and/or the like. User feedback and/or other ground truth feedback may be received with respect to claim prediction(s) 404 (e.g., via a user interface 410, in the form of new claim data, and/or the like), and such feedback may be used to retrain machine learning model 350 for improved performance and reduced false positives and/or false negatives in subsequent predictions.

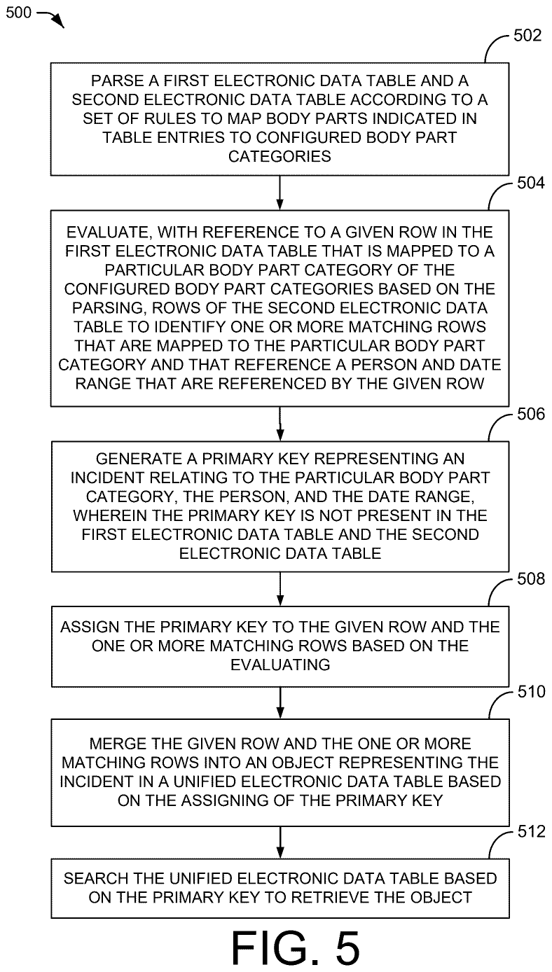

FIG. 5 is a flow diagram of a method 500 of automated claims matching across disparate electronic data sets, according to certain embodiments. For example, method 50 may be performed by one or more components described above with respect to FIGS. 1-4 (e.g., automated merging engine 150 of FIGS. 1 and 2, data retrieval and processing engine 170 of FIGS. 1 and 3, machine learning model 350 of FIGS. 3 and 4, user interface 410 of FIG. 4, and/or the like) and/or by system 600 of FIG. 6 (described below).

Method 500 may begin at 502, with parsing a first electronic data table and a second electronic data table according to a set of rules to map body parts indicated in table entries to configured body part categories.

Method 500 may continue at 504, with evaluating, with reference to a given row in the first electronic data table that is mapped to a particular body part category of the configured body part categories based on the parsing, rows of the second electronic data table to identify one or more matching rows that are mapped to the particular body part category and that reference a person and date range that are referenced by the given row.

Method 500 may continue at 506, with generating a primary key representing an incident relating to the particular body part category, the person, and the date range, wherein the primary key is not present in the first electronic data table and the second electronic data table.

Method 500 may continue at 508, with assigning the primary key to the given row and the one or more matching rows based on the evaluating.

Method 500 may continue at 510, with merging the given row and the one or more matching rows into an object representing the incident in a unified electronic data table based on the assigning of the primary key.

Method 500 may continue at 512, with searching the unified electronic data table based on the primary key to retrieve the object.

Some embodiments further comprise determining, based on evaluating the rows of the second electronic data table with reference to an additional row in the first electronic data table, that the one or more matching rows are also identified as matching the additional row and disambiguating between the given row and the additional row as a match for the one or more matching rows based on data in one or more columns of the one or more matching rows, wherein the assigning of the primary key to the given row and the one or more matching rows is further based on the disambiguating.

Certain embodiments further comprise populating one or more values of the object representing the incident in the unified electronic data table based on mapping values from corresponding columns in the given row and the one or more matching rows to a configured category.

Some embodiments further comprise populating one or more values of the object representing the incident in the unified electronic data table based on selecting between differing values in corresponding columns in the given row and the one or more matching rows according to logic that favors data from a particular type of electronic data table.

In certain embodiments, the first electronic data table comprises records of workplace injury claims, and wherein the second electronic data table comprises records of injury related encounters that are not associated in the second electronic data table with any workplace injury claims.

Some embodiments further comprise determining, based on evaluating corresponding rows of a third electronic data table with reference to a particular row of the one or more matching rows in the second electronic data table, that a respective row in the third electronic data table matches the particular row, determining that the respective row is related to the given row in the first electronic data table based on the determining that the respective row matches the particular row, assigning the primary key to the respective row based on the determining that the respective row is related to the given row. and merging the respective row into the object representing the incident in the unified electronic data table based on the assigning of the primary key to the respective row.

Certain embodiments further comprise generating a training data set based on the retrieving of the object, wherein the training data set comprises attributes related to particular incidents from the unified electronic data table associated with labels from the unified electronic data table indicating whether claims were filed in connection with the incidents and training a machine learning model though a supervised learning process, based on the training data set, to predict whether a claim is likely to be filed in connection with a given incident based on one or more attributes related to the given incident.

In some embodiments, the generating of the training data set comprising excluding, from the training data set, one or more rows from the unified electronic data table that include, in a particular column, a value that is included in fewer than a threshold amount of rows in the unified electronic data table.

In certain embodiments, the attributes related to particular incidents comprise one or more of: a geographic location; a department; a job title; a body part category; or a previous preventative action.

In some embodiments, the generating of the training data set comprises encoding the attributes into binary values.

In certain embodiments, the machine learning model comprises a tree-based model.

Some embodiments further comprise generating, based on the training of the machine learning model, a visualization of attribute distribution relative to one or more target conditions.

FIG. 6 is block diagram of a system 600 configured to implement one or more aspects related to automated claims matching across disparate electronic data sets, according to certain embodiments.

Although depicted as a single physical device, in embodiments, system 600 may be implemented using virtual device(s), and/or across a number of devices, such as in a cloud environment.

As illustrated, computing system 600 includes a central processing unit (CPU) 604, memory 616, storage 618, a network interface 608, and one or more I/O interfaces 610. In the illustrated embodiment, CPU 604 retrieves and executes programming instructions stored in memory 616, as well as stores and retrieves application data residing in storage 618. CPU 604 is generally representative of a single CPU and/or GPU, multiple CPUs and/or GPUs, a single CPU and/or GPU having multiple processing cores, and the like. Memory 616 is generally included to be representative of a random-access memory. Storage 618 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, input and output (I/O) devices (such as keyboards, monitors, etc.) can be connected via the I/O interface(s) 610. Further, via network interface 608, system 600 can be communicatively coupled with one or more other devices and components. In certain embodiments, system 600 is communicatively coupled with other devices via a network 670, which may include the Internet, local network(s), and the like. The network may include wired connections, wireless connections, or a combination of wired and wireless connections. As illustrated, CPU 604, memory 616, storage 618, network interface(s) 608, and I/O interface(s) 610 are communicatively coupled by one or more interconnects 609.

In the illustrated embodiment, memory 616 includes automated merging engine 624 and data retrieval and processing engine 625, which may correspond to automated merging engine 150 of FIGS. 1 and 2 and data retrieval and processing engine 170 of FIGS. 1 and 3. Memory 616 further includes model(s) 626, which may include machine learning model 350 of FIGS. 3 and 4. Memory 616 further includes user interface 628, which may correspond to user interface 410 of FIG. 4.

In the illustrated embodiment, storage 618 includes electronic data tables 630, which may include electronic data tables 110, 120, 130, and 140 and unified electronic data table 160 of FIG. 1. Storage 618 further includes training data 632, which may include training data generated at training data generation 320 of FIG. 3 and used at model training 330 to train one or more of model(s) 626. Storage 618 further includes incident attributes 634 and predictions 636, which may include incident attributes 402 and claim prediction(s) 404 of FIG. 4.

Other components (not shown), including USB or other port connections, film recording devices, and the like, may also be connected to I/O device interface 610. For example, an audio processor may be used to generate analog or digital audio output from instructions and/or data provided by CPU 604, memory 616, or storage 618. Communication paths interconnecting the various components in FIG. 6 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

The system 600 can be configured to perform the embodiments of the methods described above, or portions thereof. In one embodiment, the system 600 can comprise at least a CPU 604, memory 616, and one or more input and/or output devices (e.g., a display screen). The memory 616 can contain instructions which, when performed by the CPU 604, cause the system 600 to perform one or more of the steps described with reference to the methods and/or techniques described above.

It will be appreciated that the system shown herein is illustrative and that variations and modifications are possible. The connection topology may be modified as desired. For instance, in some embodiments, memory 616 is connected to CPU 604 directly rather than through an interconnect, and other devices communicate with memory 616 via interconnect 609 and CPU 604. The particular components shown herein are optional; for instance, any number of add-in cards or peripheral devices might be supported.

Network computers are another type of computer system that can be used in conjunction with the teachings provided herein. Network computers do not usually include a hard disk or other mass storage, and the executable programs are loaded from a network connection into the memory 616 for execution by the CPU 604. A Web TV system, which is known in the art, is also considered to be a computer system, but it may lack some of the features shown in FIG. 6, such as certain input or output devices. A typical computer system will usually include at least a processor, memory, and a bus coupling the memory to the processor. In some embodiments, the system 600 may include one or more CPUs 604, one or more display processors, and/or one or more of any of the system elements included in FIG. 6.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMS, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The components presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description above. In addition, the present examples are not described with reference to any particular programming language, and various examples may thus be implemented using a variety of programming languages.

While the forgoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

While the foregoing is directed to embodiments of the present invention, other and further embodiments of the invention may be devised without departing from the basic scope thereof, and the scope thereof is determined by the claims that follow.

1. A system for dynamic automated claims matching across disparate electronic data sets, comprising:
one or more processors; and
a memory storing a first electronic data table, a second electronic data table, and instructions that, when executed by the one or more processors, cause the system to:
parse the first electronic data table and the second electronic data table according to a set of rules to map body parts indicated in table entries to configured body part categories;
evaluate, with reference to a given row in the first electronic data table that is mapped to a particular body part category of the configured body part categories based on the parsing, rows of the second electronic data table to identify one or more matching rows that are mapped to the particular body part category and that reference a person and date range that are referenced by the given row;
generate a primary key representing an injury relating to the particular body part category, the person, and the date range, wherein the primary key is not present in the first electronic data table and the second electronic data table;
assign the primary key to the given row and the one or more matching rows based on the evaluating;
merge the given row and the one or more matching rows into an object representing the injury in a unified electronic data table based on the assigning of the primary key;
search the unified electronic data table based on the primary key to retrieve the object;
generate a training data set based on the retrieving of the object, wherein the generating of the training data set comprises excluding, from the training data set, one or more rows from the unified electronic data table that include, in a particular column, a value that is included in fewer than a threshold amount of rows in the unified electronic data table, and wherein the training data set comprises attributes related to particular injuries from the unified electronic data table associated with labels from the unified electronic data table indicating whether claims were filed in connection with the particular injuries; and
train a machine learning model through a supervised learning process, based on the training data set, to predict whether a claim is likely to be filed in connection with a given injury based on one or more attributes related to the given injury.

2. The system of claim 1, wherein the instructions, when executed by the one or more processors, further cause the system to:
determine, based on evaluating the rows of the second electronic data table with reference to an additional row in the first electronic data table, that the one or more matching rows are also identified as matching the additional row; and
disambiguate between the given row and the additional row as a match for the one or more matching rows based on data in one or more columns of the one or more matching rows, wherein the assigning of the primary key to the given row and the one or more matching rows is further based on the disambiguating.

3. The system of claim 1, wherein the instructions, when executed by the one or more processors, further cause the system to populate one or more values of the object representing the injury in the unified electronic data table based on mapping values from corresponding columns in the given row and the one or more matching rows to a configured category.

4. The system of claim 1, wherein the instructions, when executed by the one or more processors, further cause the system to populate one or more values of the object representing the injury in the unified electronic data table based on selecting between differing values in corresponding columns in the given row and the one or more matching rows according to logic that favors data from a particular type of electronic data table.

5. The system of claim 1, wherein the first electronic data table comprises records of workplace injury claims, and wherein the second electronic data table comprises records of injury related encounters that are not associated in the second electronic data table with any workplace injury claims.

6. The system of claim 1, wherein the instructions, when executed by the one or more processors, further cause the system to:
determine, based on evaluating corresponding rows of a third electronic data table with reference to a particular row of the one or more matching rows in the second electronic data table, that a respective row in the third electronic data table matches the particular row;
determine that the respective row is related to the given row in the first electronic data table based on the determining that the respective row matches the particular row;
assign the primary key to the respective row based on the determining that the respective row is related to the given row; and
merge the respective row into the object representing the injury in the unified electronic data table based on the assigning of the primary key to the respective row.

7. (canceled)

8. (canceled)

9. The system of claim 1, wherein the attributes related to particular incidents comprise one or more of:
a geographic location;
a department;
a job title;
a body part category; or
a previous preventative action.

10. The system of claim 1, wherein the generating of the training data set comprises encoding the attributes into binary values.

11. The system of claim 1, wherein the machine learning model comprises a tree-based model.

12. The system of claim 1, wherein the instructions, when executed by the one or more processors, further cause the system to generate, based on the training of the machine learning model, a visualization of attribute distribution relative to one or more target conditions.

13. A method of dynamic automated claims matching across disparate electronic data sets, comprising:
parsing a first electronic data table and a second electronic data table according to a set of rules to map body parts indicated in table entries to configured body part categories;
evaluating, with reference to a given row in the first electronic data table that is mapped to a particular body part category of the configured body part categories based on the parsing, rows of the second electronic data table to identify one or more matching rows that are mapped to the particular body part category and that reference a person and date range that are referenced by the given row;
generating a primary key representing an injury relating to the particular body part category, the person, and the date range, wherein the primary key is not present in the first electronic data table and the second electronic data table;
assigning the primary key to the given row and the one or more matching rows based on the evaluating;
merging the given row and the one or more matching rows into an object representing the injury in a unified electronic data table based on the assigning of the primary key;
searching the unified electronic data table based on the primary key to retrieve the object;
generate a training data set based on the retrieving of the object, wherein the generating of the training data set comprises excluding, from the training data set, one or more rows from the unified electronic data table that include, in a particular column, a value that is included in fewer than a threshold amount of rows in the unified electronic data table, and wherein the training data set comprises attributes related to particular injuries from the unified electronic data table associated with labels from the unified electronic data table indicating whether claims were filed in connection with the particular injuries; and
train a machine learning model though a supervised learning process, based on the training data set, to predict whether a claim is likely to be filed in connection with a given injury based on one or more attributes related to the given injury.

14. The method of claim 13, further comprising:
determining, based on evaluating the rows of the second electronic data table with reference to an additional row in the first electronic data table, that the one or more matching rows are also identified as matching the additional row; and
disambiguating between the given row and the additional row as a match for the one or more matching rows based on data in one or more columns of the one or more matching rows, wherein the assigning of the primary key to the given row and the one or more matching rows is further based on the disambiguating.

15. The method of claim 13, further comprising populating one or more values of the object representing the injury in the unified electronic data table based on mapping values from corresponding columns in the given row and the one or more matching rows to a configured category.

16. The method of claim 13, further comprising populating one or more values of the object representing the injury in the unified electronic data table based on selecting between differing values in corresponding columns in the given row and the one or more matching rows according to logic that favors data from a particular type of electronic data table.

17. The method of claim 13, wherein the first electronic data table comprises records of workplace injury claims, and wherein the second electronic data table comprises records of injury related encounters that are not associated in the second electronic data table with any workplace injury claims.

18. The method of claim 13, further comprising:
determining, based on evaluating corresponding rows of a third electronic data table with reference to a particular row of the one or more matching rows in the second electronic data table, that a respective row in the third electronic data table matches the particular row;
determining that the respective row is related to the given row in the first electronic data table based on the determining that the respective row matches the particular row;
assigning the primary key to the respective row based on the determining that the respective row is related to the given row; and
merging the respective row into the object representing the injury in the unified electronic data table based on the assigning of the primary key to the respective row.

19. (canceled)

20. A non-transitory computer readable medium storing a first electronic data table, a second electronic data table, and instructions that, when executed by one or more processors of a computing system, cause the computing system to:
parse the first electronic data table and the second electronic data table according to a set of rules to map body parts indicated in table entries to configured body part categories;
evaluate, with reference to a given row in the first electronic data table that is mapped to a particular body part category of the configured body part categories based on the parsing, rows of the second electronic data table to identify one or more matching rows that are mapped to the particular body part category and that reference a person and date range that are referenced by the given row;
generate a primary key representing an injury relating to the particular body part category, the person, and the date range, wherein the primary key is not present in the first electronic data table and the second electronic data table;
assign the primary key to the given row and the one or more matching rows based on the evaluating;
merge the given row and the one or more matching rows into an object representing the injury in a unified electronic data table based on the assigning of the primary key;
search the unified electronic data table based on the primary key to retrieve the object;
generate a training data set based on the retrieving of the object, wherein the generating of the training data set comprises excluding, from the training data set, one or more rows from the unified electronic data table that include, in a particular column, a value that is included in fewer than a threshold amount of rows in the unified electronic data table, and wherein the training data set comprises attributes related to particular injuries from the unified electronic data table associated with labels from the unified electronic data table indicating whether claims were filed in connection with the particular injuries; and
train a machine learning model though a supervised learning process, based on the training data set, to predict whether a claim is likely to be filed in connection with a given injury based on one or more attributes related to the given injury.
